(19) United States
(12) Patent Application Publication
(10) Pub. No.: US 2026/0368152 A1
(43) Pub. Date: Nov. 19, 2026

(54) Efficient Change Tracking Of Tables

(71) Applicant: Oracle International Corporation, Redwood Shores, CA (US)

(72) Inventors: Kishy Kumar, Santa Clara, CA (US); Ananth Raghavan, Mountain View, CA (US); Paul Shin, San Mateo, CA (US); Nisarg Pranav Shah, Milpitas, CA (US); Meixuan Li, Foster City, CA (US); Tianyi Li, Sunnyvale, CA (US); Ajit Mylavarapu, Mountain View, CA (US); Tarpit Sahu, Uttarakhand (IN); Arnab Das, West Bengal (IN)

(21) Appl. No.: 19/268,854

(22) Filed: Jul. 14, 2025

Related U.S. Application Data
(60) Provisional application No. 63/781,305, filed on Mar. 31, 2025.

(51) Int. Cl. G06F 16/23; G06F 16/21; G06F 16/22; G06F 16/27

(52) U.S. Cl. CPC G06F 16/2358; G06F 16/219; G06F 16/2282; G06F 16/278

(57) ABSTRACT

Table notifications journal changes to columns to a change tracking table. The changes are accessible in the change tracking table as soon as the database transactions commit. Table notifications are implemented in a DBMS.

### RELATED APPLICATION

The present application claims priority to U.S. Provisional Patent Application No. 63/781,305, entitled Directives for JSON Duality Views, filed by Kishy Kumar, et al. on Mar. 31, 2025, the entire contents of which are incorporated herein by reference.

### FIELD OF THE INVENTION

The present disclosure relates to the change tracking of database tables stored in Database Management System (DBMS).

### BACKGROUND

Tracking and reporting column changes made by database transactions to specific database tables (e.g. table) in a DBMS is an important function. The information may be used to replicate changes to other systems, such as to a replica database or a type of service, and to update middle-tier caches that store the column data that has changed. In addition, the change information, once replicated, may be queried or otherwise examined for a variety of purposes. For example, determining changes to a row that occurred between two SCNs (“system change number”). Determining the last SCN (“system change number”) at which any of a set of rows was changed; this information may be used to route queries to a replica (e.g. read-only standby database) that reflects changes as of that last SCN or beyond. Reporting such change information and making the change information accessible for querying and examination to support a variety of purposes is referred to herein as database change notification.

In the state of the art, database change notification for changes made by a database transaction is not initiated until after a database transaction commits, when further processing of the change information is performed to replicate or communicate the change information to other systems. Many database change notification mechanisms use redo logs generated by database transactions to extract data for database change notifications. Through a process referred to herein as redo mining, the redo records are scanned and examined to determine the column values changed. Data about the changes in the redo log is extracted and transformed into a form needed for replication or for communicating with other services. These processes generally entail storing the extracted and transformed change information into data structures that are used to stage the change information for replication or communication to other systems and services. The processes take time, thereby delaying database change notification.

### BRIEF DESCRIPTION OF THE DRAWINGS

In the drawings:

FIG. 1 depicts a syntax for defining a table notification directive, according to an embodiment of the present invention.

FIG. 2 depicts change tracking tables and a commit SCN log according to an embodiment of the present invention.

FIG. 3 depicts a partitioned table family for a commit SCN log and change tracking tables, according to an embodiment of the present invention.

FIG. 4 depicts a procedure for journaling changes to a change tracking table according to an embodiment of the present invention.

FIG. 5A depicts a commit of a database transaction, according to an embodiment of the present invention.

FIG. 5B depicts a commit of a database transaction, as augmented with commit patching, according to an embodiment of the present invention.

FIG. 6 depicts a procedure for active-partition succession, according to an embodiment of the present invention.

FIG. 7 is a block diagram that illustrates a computer system upon which an embodiment of the invention may be implemented.

FIG. 8 is a block diagram of a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, structures and devices are shown in block diagram form in order to avoid unnecessarily obscuring the present invention.

### Overview

Described herein are novel forms of database change notifications referred to as table notifications. Table notifications journal changes to columns to a change tracking table. The changes are accessible in the change tracking table as soon as the database transactions commit. Table notifications are implemented in a DBMS.

In an embodiment, the changes made by a database transaction to one or more columns of a row in a database table are journaled to a respective change tracking table. Just as the column values as changed by a database transaction are visible to other database transactions when the database transaction commits, the changes journaled to the change tracking table are visible to other database transactions when the database transaction commits. A database table whose changes are journaled to a change tracking table is referred to as a journaled table; the changed columns that are journaled are referred to herein as logged columns. Rows in a journaled table are referred to herein as journal rows.

### Notification Directive for History Tracking

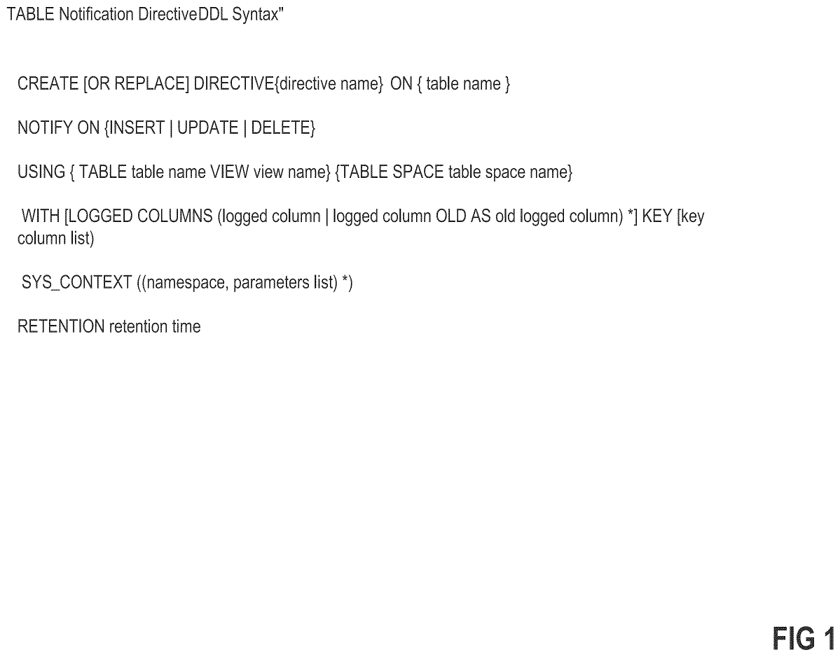

FIG. 1 depicts an illustrative syntax for a DDL statement used to define a table notification directive for a database table. Describing the syntax serves an introduction and overview of table notifications.

Referring to FIG. 1, the DIRECTIVE and ON clauses take arguments for defining a journaled table, the database table for which the directive is defined.

The NOTIFY ON clause specifies one or more “on-DML types” for which to journal a change to a row in the journaled table, which may be any combination of INSERT, UPDATE, or DELETE. An on-DML type specifies a category of DML operation executed against a journaled table for which row changes are journaled.

The USING clause includes a TABLE clause for specifying the table name of a change tracking table, a TABLESPACE clause for specifying a tablespace of database files that may be used to store the change tracking table, and a VIEW clause for specifying a view name for a “historical view” for accessing the information in the change tracking table. A tablespace is a named set of database files defined by a DBMS for storing database objects, such as database tables.

The historical view provides a convenient mechanism for accessing the change tracking data that eliminates the need to implement more complex query statements that would otherwise be required, given the complexity and accessibility of tables used for journaling, as further described below.

The WITH clause includes two arguments: the LOGGED COLUMNS clause for defining “logged” columns of a journaled table and a KEY clause. The LOGGED COLUMNS clause references a column in a journaled table by column name. As mentioned, a logged column is a column in a journaled table whose changes are tracked in a change tracking table in a counterpart column. The counterpart column has the same name. The counterpart column in the change tracking table is referred to herein as a journal column.

The KEY clause defines one or more logged columns to use as an identifying key for the respective change tracking table. Usually, the KEY references a primary or unique key of the respective journaled table. In an embodiment, a key clause may be required.

For a row in a journaled table generated by a database transaction, a journal column stores in the journal column the logged column value to which the value changed to by a database transaction. For example, if a logged column SALARY is changed from an old value to a new value, the respective journal column stores the new value.

However, the old value may also be stored in a journal column. In a DDL statement defining a table notification directive, a logged column name followed by the suffix OLD AS defines a journal column in the change tracking table that holds the previous value of the referenced logged column. The column argument following the suffix OLD AS defines a journal column name in the respective change tracking table for storing the old value.

SYS_CONTEXT clause, when present, specifies to store database session information about the database transaction that generates a journal row. The SYS_CONTEXT clause will be explained in further detail later.

The RETENTION clause specifies a retention time for retaining journal rows in the change tracking table.

Below is an example DDL statement defining a table notification directive.
CREATE DIRECTIVE NOTIFY_EMPLOYEE_TAB ON EMPLOYEE
USING EMPLOG VIEW EMPLOG_V
WITH LOGGED COLUMNS EMPNAME, SALARY, SALARY OLD AS SALARY_OLD
KEY EMPID
RETENTION 10 HRS

The DDL statement above defines the following:
A directive named notify_employee_tab for table EMPLOYEE.
A change tracking table named EMPLOG and a historical view named EMPLOG_V.
A key for EMPLOG named EMPID, the primary key for table EMPLOYEE.
Logged columns EMPNAME, SALARY of table EMPLOYEE, and a column for holding the old value of SALARY, named SALARY_OLD.
A retention period of 10 years.

The DDL statement does not specify an on-DML type or tablespace name. In this case, a default is used: row changes are journaled for all on-DML types, and the DBMS assigns a tablespace for the respective change tracking table. If the DDL statement for a table notification directive does not specify logged columns in the LOGGED columns clause, all user-defined columns are treated as logged columns.

If the RETENTION clause has not been provided, then journal rows in the journaled table may be retained indefinitely. A DBMS may provide a utility that a database user may call to purge journal rows according to parameters that may be specified when calling the utility. The utility is described later.

In response to receiving a DDL statement defining a table notification directive for a journaled table, not only does a DBMS store the table notification directive as metadata in a database dictionary, but the DBMS also creates a change tracking table and begins to journal changes to the change tracking table, as described below.

### Change Tracking Table Infrastructure Overview

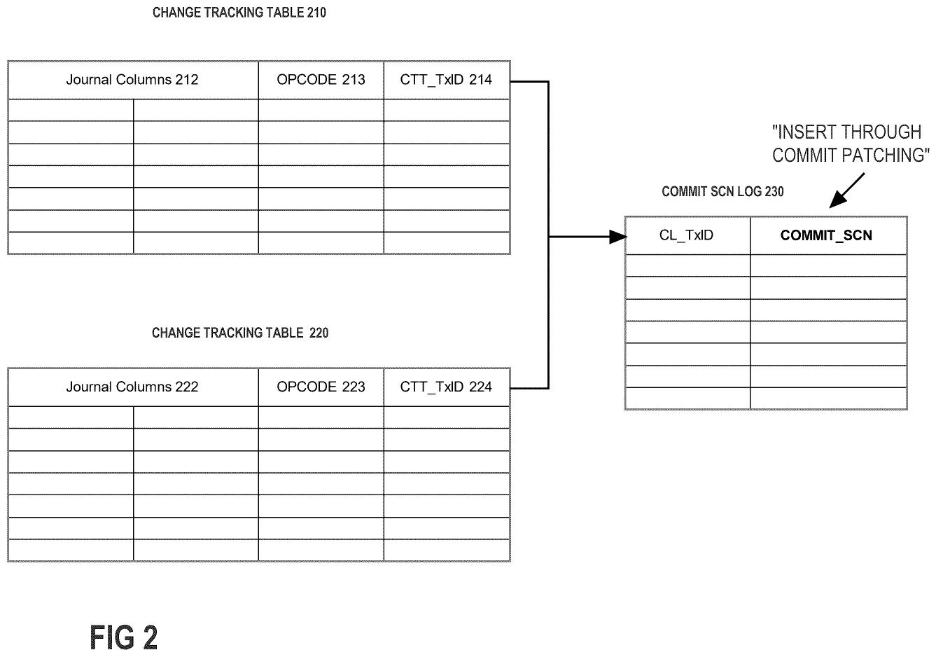

FIG. 2 depicts change tracking tables and an important adjunct table referred to herein as a commit SCN log. The commit SCN log includes a single row for a database transaction that generated a row in one or more change tracking tables. The row inserted into the commit SCN log includes a commit SCN and a database transaction ID of the database transaction. A commit SCN is explained later. The database transaction ID links a row in the commit SCN log with one or more journal rows in the change tracking table that store the same database transaction id.

Referring to FIG. 2, it depicts Change Tracking Table 210 and Change Tracking Table 220, which record changes for logged columns of a respective journaled table. Each journal row in a change tracking tables records changes made by a database transaction to a row in a respective journaled table. The database transaction is identified by a database transaction ID stored in either columns CTT_TxID 214 and CTT_TxID 224 of Change Tracking Tables 210 and 220, respectively. The logged column values are stored in Journal Columns 212 and 222.

Columns OPCODE 213 and 223 store codes; for a particular journal row, the code represents the type of DML operation that caused the generation of the journal row. In an embodiment, one of three codes is stored in an OPCODE column, each representing one of an INSERT, UPDATE, or a DELETE, respectively.

The arrangement of change tracking tables and commit SCN log provides several important advantages. The change tracking tables may be queried by commit SCN by joining the change tracking table with the commit SCN log using the database transaction ID stored in both tables as an equijoin key. In addition, at commit time, only one row, i.e., a row in the commit SCN log, needs to be updated through a procedure referred to herein as commit patching. Commit patching provides transaction consistency between the commit SCN recorded for a database transaction and the logged column values of one or more rows journaled for the database transaction. To provide this transactional consistency, it is important that the number of rows that need to be updated to store the commit SCN is few in number, if not one. Reasons for this requirement are explained later. If the commit SCN were stored in a column of a change tracking table, then this approach may require updating a column in many rows of one or more change tracking tables.

Querying a change tracking table that filters rows based on commit SCNs involves joining a history table with a commit SCN log. To provide end-user access to information in a history table and to facilitate the design of queries based on commit SCN columns, a history view joins the change tracking table and commit SCN log and projects columns from each.

An important column projected is the key defined for a change tracking table. A key uniquely identifies a row in the journaled table. A row may be stored as two physical rows (e.g. in different data blocks) at respective different times but may be considered the same logical row throughout because the row retains the same key value. The history view may be used to query when a key value of a row changes, which, at least logically, may be when the row becomes a different row.

### Partitioning

For reasons that will be explained later, change tracking tables and a commit SCN log are partitioned. In general, a table may be partitioned based on a partition key and a variety of partitioning techniques as follows. Under range partitioning, a partition is associated with one or more distinct ranges of partition key values. When a row having a partition key value is inserted, it is inserted into the partition that is associated with the range into which the partition key value falls. Under list partitioning, partitions are each associated with a value. When a row having a partition key value is inserted, it is inserted into the partition that is associated with the partition key value. Under system partitioning, a DML command that inserts or updates a row identifies the partition to which the row belongs. The DBMS either inserts into the identified partition or moves the row there in the case of an update that changes the partition of a row. Under hash partitioning, rows are distributed across partitions according to a hash scheme.

A powerful feature for partitioning related tables is a partitioned table family. A partition table family comprises database tables that are related based on a foreign-key:primary-key (FK:PK) relationship. A child table in a family is a table that has a FK: PK relationship with a parent table.

In partitioned table families, all of the child tables of a table family are partitioned by inheriting the partitioning key from the parent table of the table family. For each partition of a parent table, there is a corresponding partition for the child table that is partitioned by the inherited parent key. A partition of the parent table is referred to as a parent partition, and the partition of the child table is referred to as a child partition; the parent partition and its corresponding child partition are referred to as parent and child with respect to each other and referred to together as a partitioned table subfamily. Finally, the partition key of the parent table is used as the partition key for all tables in the table family.

### Commit Log Partitioning

To accelerate queries that access a change tracking table that filters rows based on the commit SCN column of the commit SCN log, the commit SCN column may be indexed. However, inserting or updating an indexed column may entail modifying a data block that stores the index. An SCN is a monotonically increasing number that will cause “right growing” in an index, where consecutive changes to the index concentrate access on the same “hot” data block. As a consequence, many database transactions adding a key value to the index contend for the same data block, which can delay the commit patching. Furthermore, adding a new key value to an index may trigger a data block split operation to allow the index to grow.

To facilitate indexing in a way that minimizes or eliminates problems attendant to modifying an indexed column during commit patching, the commit SCN log and change tracking tables are partitioned. In partitioning, a table is split into multiple partitions that are stored in respective sets of data blocks.

According to an embodiment of the present invention, a commit SCN log is partitioned into multiple partitions. At commit time, rows are inserted into one partition of the commit SCN log, which is referred to herein as the active partition. Eventually, the active partition is replaced by another partition, and inserts to the commit SCN log are directed to the new active partition. In response to an active partition being replaced by another active partition, the former active partition is indexed. Hence, the partitions in the commit SCN log other than the active partition may be indexed.

### Commit SCN Log Partition Family

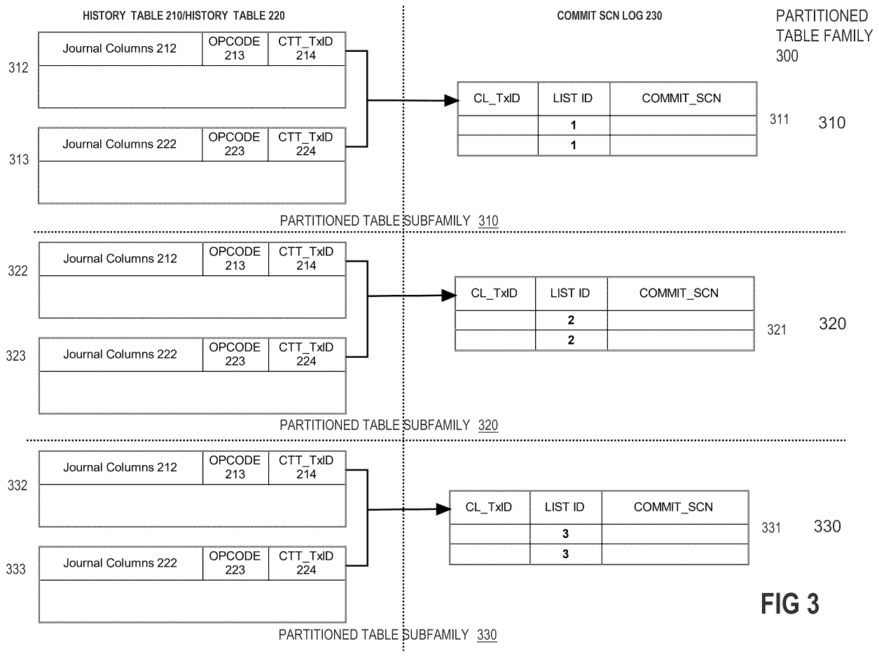

FIG. 3 shows a partitioned table family 300 for commit SCN log 230 and change tracking tables 210 and 220. Commit SCN log 230 includes column LIST ID, which is used as a partition key for list partitioning. Commit SCN log 230 is the parent table of the partitioned table family 300. As such, LIST ID is the inherited partition key for change tracking tables 210 and 220. In an embodiment, list partitioning is used because of limitations regarding the stage at which commit patching is performed at commit time. However, an embodiment is not limited to list partitioning; other forms of partitioning may be used.

FIG. 3 depicts partitioned table subfamilies 310, 320, and 330, which include, respectively, (1) parent partition 311 of commit SCN log 230 and child partitions of 312 and 313 of change tracking tables 210 and 220, respectively, (2) parent partition 321 of commit SCN log 230 and child partitions of 322 and 323 of change tracking tables 210 and 220, respectively, and (3) parent partition 331 of commit SCN log 230 and child partitions 332 and 333 of change tracking tables 210 and 220, respectively.

The partition key values in LIST ID that are associated with each of the partitioned table subfamilies 310, 320, and 330 are 1, 2, and 3, respectively. Each row in change tracking tables 210 and 220 has a foreign key value (i.e., database transaction ID) matching a row in a parent partition of commit SCN log 230 and is in a respective child partition for the parent partition. When a row is inserted into either of change tracking tables 210 and 220, the row is inserted into the child partition of the parent partition having the row with the primary key value matching the foreign key value of the row being inserted, that is, with matching database transaction IDs in the respective foreign and primary keys.

At any given point in time, a parent table partition of a commit SCN log 230 is active. This feature is accomplished in part by defining a default value for LIST ID. A row is inserted in the commit SCN log 230 without specifying a value for LIST ID. Inserting rows in this way triggers the DBMS to populate LIST ID with the default value. The default value for LIST ID, in effect, establishes the active parent partition and “active” partitioned table subfamily. Rows inserted into the change tracking tables 210 and 220 by a database transaction have a database transaction ID (in foreign key CTT_TxID 214 or CTT_TxID 224, respectively) that matches the primary key CL_TX_ID of the row inserted into commit SCN log 230 by the database transaction. As a result, the rows are inserted into the child partitions of the active parent partition and active partitioned table subfamily.

In an embodiment, system partitioning may be used. A DML insert operations that inserts a row into a change tracking table identifies an active child partition for the change tracking table. Similarly, an insert operation of a row into the commit SCN log identifies the active partition of the commit SCN log.

### Journaling to the Commit Tracking Tables

In general, updates and inserts to rows to a database table are made on a row-by-row basis, each change to a row changing a data block (in a data block buffer) that stores the row. Thus, changes to data blocks that store rows are made on a row-by-row basis.

Journaling changes of a journaled table to a change tracking table adds the overhead of inserting rows into another table. Insert operations require less work to perform than update operations, and journaling changes to a journaled table is predominately performed through insert operations. However, to even further minimize the overhead of inserting journal rows, journal rows are not inserted on a row-by-row basis with respect to the changes made to rows in the journaled table. Instead, information about the changed rows is stored and accumulated as change records in an in-memory cache. The change records are used to insert journal rows using an efficient batch mode. The in-memory cache is referred to herein as the row-changes cache.

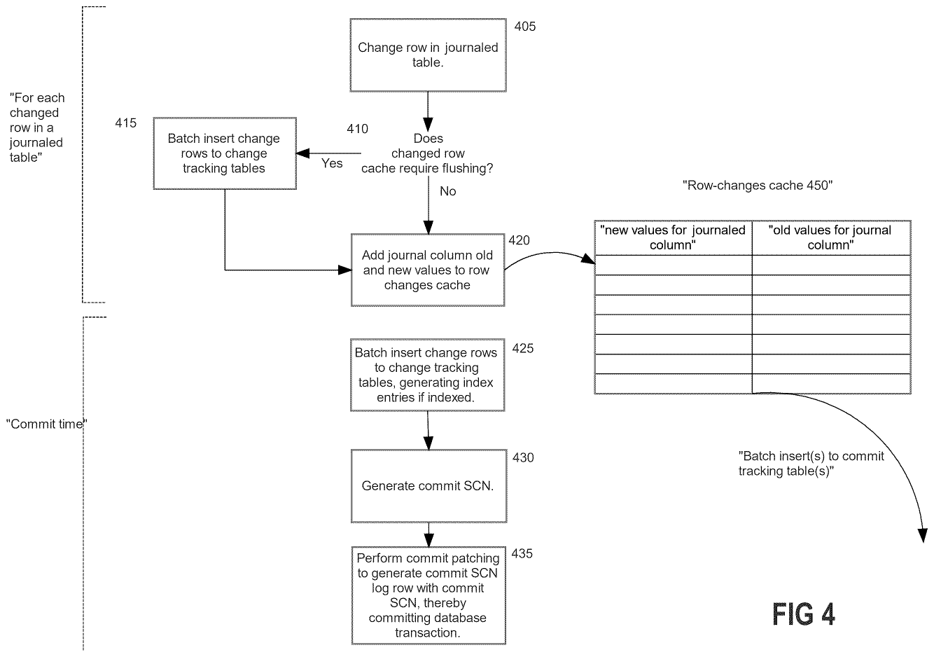

FIG. 4 depicts operations performed for journaling journal rows to change tracking tables. The operations are incorporated into the operations a database transaction performs when making DML changes to a journaled table and committing the changes.

Referring to FIG. 4, the database transaction changes a row in a journaled table. (405) The row change requires adding a change record to the row-changes cache 450. A change record for a particular journaled table includes a new column value for each logged column. In the case of an insert DML operation, the new values include the journal column values inserted by the database transaction; there are no old values. In the case of an update DML operation, new values include the values to which any logged column was updated. The old values include the values of any logged column before the logged column value was changed by the database transaction. In the case of a delete DML operation, the old values include the values of any logged column before the delete, and the new values include only the key value.

The amount of memory allocated to a row-changes cache is limited. There may be insufficient memory to store another change record. Thus, before a change record is added to the row-changes cache 450, a determination is made of whether the row-changes cache should be flushed because the cache has insufficient memory to store another change record. (410).

If so, then row-changes cache 450 is flushed, which requires inserting journal rows into one or more change tracking tables. A database transaction may change multiple journaled tables, and thus, the row-changes cache may include change records for multiple journal tables. Journal rows for a change tracking table are inserted into the change tracking table using a batch insert. A batch insert adds multiple rows together into a data block in a database. (415). The journal rows inserted into change tracking tables contain column values specified by the table notification directive of the respective journaled table of the change tracking table, as well as the database transaction ID of the database transaction.

At commit time, journal rows for the change records in the row-changes cache 450 are batch inserted into respective change tracking tables. The batch insert is performed before performing operations that complete the commit of the database transaction.

Specifically, the batch insert must be performed before generating the commit SCN of a database transaction (430), for reasons that will be explained. Commit patching is used to insert a row into the commit SCN log that includes the database transaction ID and commit SCN for the database transaction. (435)

As mentioned before, rows inserted into the commit SCN log are inserted into the active partition. Likewise, journal rows inserted into a change tracking table are inserted into the active partition of the change tracking table.

### Transactional Processing Consistency

As mentioned previously, transactional consistency is a reason that a commit SCN for a database transaction is stored in a column of a single row in the commit SCN log rather than in a column of change tracking tables. Therefore, an explanation of transactional consistency is useful.

Rows in a database are changed by database transactions. A database transaction makes the changes permanent by committing the changes. The changes committed by a database transaction are also assigned to a unique commit SCN (system change number) that is not associated with other changes committed by other database transactions. A database transaction is assigned a commit SCN that is greater than any previously assigned SCN. The order of the commit SCNs of database transactions reflects the respective order of the changes committed by the database transactions.

As database transactions commit changes to a database, the database changes from one committed state to another, each committed state being associated with a distinct commit SCN. The committed state of a database as of a given commit SCN reflects the changes committed at or before the commit SCN.

A row may be changed by multiple database transactions. Each change committed by a database transaction to the row is associated with a row commit SCN, which is the commit SCN of the database transaction that made the change. The state of the row that reflects the change is referred to as being the state or committed state of or associated with the row commit SCN. The state or committed state of a row that is consistent with an SCN is the committed state of a row at the row commit SCN that is closest to or equal to the SCN.

A row may be associated with multiple row commit SCNs. Versions of the row are associated with the multiple row commit SCNs, respectively, or, in other words, each row commit SCN of a row is associated with a committed state of the row. The latest row commit SCN of a row is referred to as the row's current row commit SCN.

Not every SCN generated by a DBMS for a database is a commit SCN. SCNs are generated for a variety of purposes and events. A DBMS maintains a current SCN for a database. To generate an SCN to assign to an event, such as generating a commit SCN to assign to the commit of a database transaction, the current SCN is incremented and then assigned, or assigned and then incremented. The current SCN is monotonic.

When a database transaction is initiated, the database transaction is assigned a transaction start SCN. When a database transaction commits, a commit SCN is assigned to a committed database transaction, and the assigned commit SCN is greater than or later to the transaction start SCN of the database transaction.

As a database transaction executes and changes database data, the database transaction may execute database read operations (e.g., for query statements or DML statements) to read database data from the database. The read operations are performed according to a protocol referred to herein as a consistent read. In a consistent read, there are two types of “in-flight changes”. In-flight changes are changes made by in-flight database transactions, which are database transactions that have not been committed or otherwise terminated. With respect to a given in-flight database transaction, in-flight changes being made by another uncommitted database transaction are referred to herein as external in-flight changes. In-flight changes being made by the given database transaction may be referred to herein as local in-flight changes with respect to the given database transaction. For purposes of exposition, with respect to a database transaction, external in-flight changes may be referred to as external dirty changes; the data or rows being changed by external changes are referred to herein as externally dirty data or rows. The local in-flight changes of the database transaction may be referred to as the local dirty changes with respect to the database transaction; the data or rows changed by the local changes are referred to as locally dirty.

In a DBMS, when a database transaction changes a row, it first obtains an exclusive lock on the row. The lock is released when the database transaction is committed. Locking rows in this way means that with respect to a row in a database, only one in-flight database transaction is changing the row. Once an in-flight database transaction obtains an exclusive lock, no other in-flight database transaction may change the row until the database transaction commits or otherwise terminates.

### Consistent Read

When executing a database statement in consistent read mode, rows are read, processed and/or returned in a way that reflects local dirty changes. For rows not changed by the database transaction, the rows are processed and returned in a way that is consistent with their committed state as of a “snapshot time” assigned to the execution of the database statement. A snapshot time is an SCN. Some of the rows not changed by the database transaction may be externally dirty. A consistent read mechanism adjusts the state of these rows for the database transaction so that the state is consistent with the snapshot time.

When the state of a row read or otherwise processed by a database transaction reflects changes made to the row, the changes are referred to herein as being visible or seen by the database transaction. When a state of a row that is read or otherwise processed by a database transaction does not reflect the changes made to the row, the changes are referred to herein as being not visible or not seen by the database transaction. In consistent read mode, local dirty changes of a database transaction are visible to the database transaction, while externally dirty changes are not visible. The local dirty changes of the database transaction are not visible to other database transactions under consistent read.

A snapshot time is assigned to the execution of a database statement when the execution of a database statement is requested by the database transaction or otherwise commenced by the database transaction. If a database transaction executes different database statements at different times, the executions are assigned different snapshot times, with the later execution of a database statement being assigned a later snapshot time.

For example, a first database transaction begins and executes a DML statement that makes first changes to a first set of rows in an employee table. Later, a second database transaction begins execution and makes second changes to a second set of rows in the employee table.

After the second changes are made by the second database transaction and before either database transaction commits, the first database transaction executes a first database statement that reads rows from the employee table. The first query is assigned a snapshot SCN of 15. Execution of the query returns the first set of rows changed by the first database transaction and the second set of rows changed by the second database transaction. The first set of rows that are read reflects local dirty changes made by the first database transaction, and the second set of rows that are read do not reflect the external dirty changes made by the second database transaction.

After execution of the first query, the second database transaction commits and is assigned a commit SCN of 25. Next, the first database transaction executes a second query with a snapshot time of 30. The execution of the second query reads rows from the employee table that include the second set of rows. The second set of rows now reflects the changes made by the second database transaction.

### Complications Recording Transactionally Consistent Commit SCNs

Due to complexities regarding the determination and assignment of commit SCNs during the commit phase of a database transaction, storing the commit SCN in a single column of a single row in a commit SCN log enables storing a transactionally consistent commit SCN for all the journal rows generated by a database transaction. To illustrate why, problems arising from maintaining a column for a commit SCN in a change tracking table are described.

In the illustration, a change tracking table includes a column that holds the commit SCN of the database transaction that changed the logged columns of the change tracking tables. The column is named COMMIT_SCN.

A row is inserted into the change tracking table by a database transaction by issuing a DML statement directed to the change tracking table. The commit SCN for the database transaction is generated during commit time at a point where no further DML statements can be processed by the database transaction, including a DML statement to insert a row into a change tracking table. Importantly, this restriction means that the COMMIT_SCN cannot be updated by the execution of a DML statement after the commit SCN has been determined.

As a consequence, when a row is inserted into the change tracking table, the commit SCN is not known, and thus, the COMMIT_SCN column is not yet populated by the insert. It can be asynchronously populated later by another database transaction. However, this leaves open a period of time during which the COMMIT_SCN column is not populated. Returning logged column values unassociated with the related commit SCN is inconsistent and can be problematic.

Furthermore, updating the COMMIT_SCN column asynchronously creates a transactionally inconsistency that remains even after the column is asynchronously populated. The commit SCN of a database transaction is not only the commit SCN of the journal columns values stored in the journal row, but also the row commit SCN of the journal row itself. The later update of COMMIT_SCN of the row to populate the row has a later commit SCN. This leaves open a window of time between the original commit SCN of the insert and the later commit SCN in which a committed state of the row has no COMMIT_SCN value. Any database transaction that reads the changes using a range select query on commit SCN within the window of time sees only the unpopulated column.

For example, assume a database transaction that changes a row in a journaled table has a commit SCN of 10000. To journal the change, the database transaction inserts a journal row into the respective change tracking table. Therefore, the insert of the new row in the change tracking table also has row commit SCN 10000. Later, the COMMIT_SCN in the row is asynchronously updated by a later database transaction to 10000; however, the update itself has a commit SCN of 11000.

Meanwhile, a database transaction is executing a query having a predicate filter on COMMIT_SCN that requires that the column be greater than or equal to 10000. In other words, the query returns journaled objects changed on or after SCN 10000. The snapshot time of the query is 10400. Based on consistent read, the database transaction reads the row based on the committed state of the row as of SCN 10400, which does not include a populated COMMIT_SCN. The row is not returned because the unpopulated column does not match the predicate filter, which is an error.

COMMIT_SCN is an example of a “commit SCN column”. The SCN in a commit SCN column of a row, in effect, asserts the SCN of the committed state of values in other columns of that row.

In an embodiment, the above-illustrated transactional consistency for the commit SCN column COMMIT_SCN is overcome by populating a commit SCN column atomically with the commit of the database transaction using commit patching described below. However, before describing commit patching, it is useful to describe how a database transaction is atomically committed.

### Atomically Committing Transactions

Database data for database tables is stored in data blocks. Updating, inserting, or deleting a row in a database table entails modifying a data block that stores the row. To modify the row, the data block is read into a database buffer in memory and then modified. A redo record is generated within a log buffer to record the modification. The redo record is written persistently to a persistent log. A database transaction does not commit until all the redo records recording the changes made by the database transaction to rows in data blocks are stored persistently in the persistent log. A database transaction may change many data blocks in multiple tables and generate many redo records. The database transaction is committed atomically by writing and persisting a single redo record for a single data block, as described below.

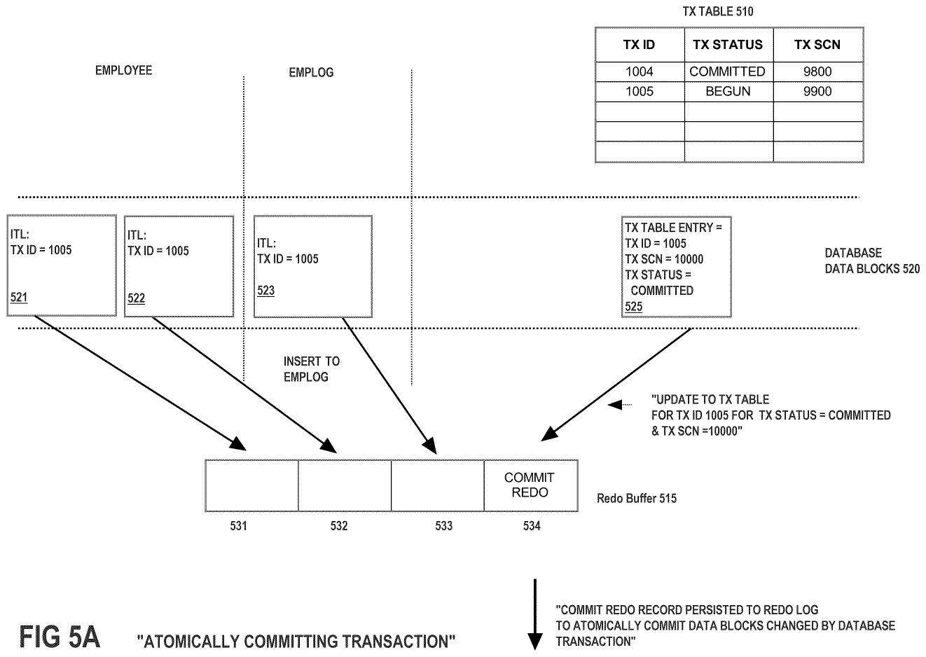

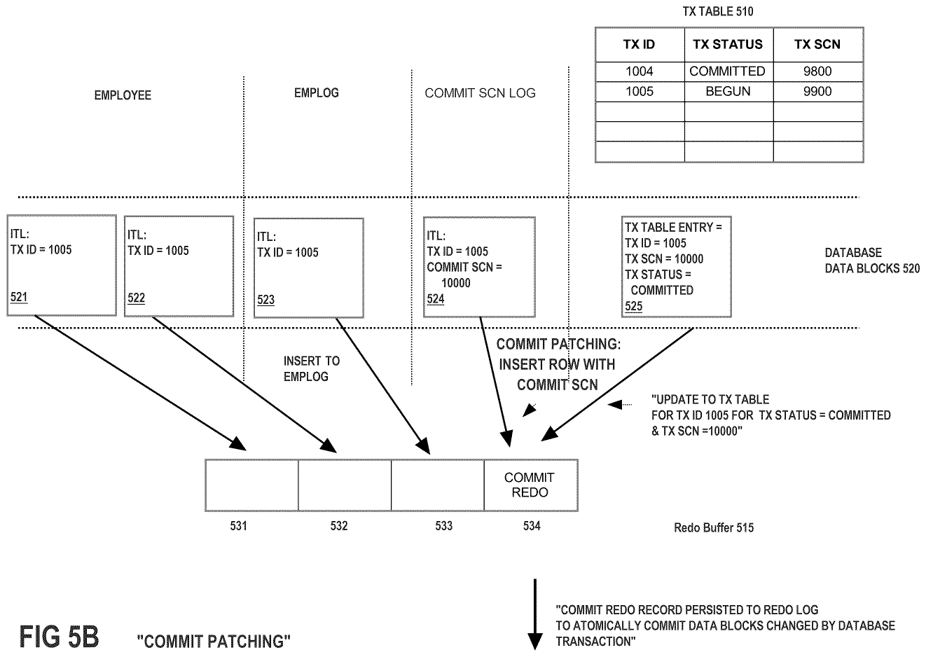

FIG. 5A depicts data blocks and a redo buffer used to illustrate how a database transaction is atomically committed. Atomically committing a database transaction also uses a transaction table that tracks the status of database transactions and SCNs associated with the database transactions, such as the begin SCN and commit SCN.

Referring to FIG. 5A, TX table 510 is a system table used to track and manage database transactions executed within a DBMS. TX table 510 includes three columns, TX ID, TX STATUS, and TX SCN, which hold transaction IDs, transaction statuses, and SCNs. Each entry, which holds a database transaction ID of a database transaction, stores the transaction status and the commit SCN of the database transaction; the semantics of the SCN depends on the transaction status of the database transaction. For example, for the entry with transaction ID 1004, the transaction status is COMMITTED. Therefore, the SCN in the column TX SCN is commit SCN=9800 of database transaction 1004. For the entry with transaction ID 1005, the transaction status is BEGUN, and therefore, the SCN in TX SCN is beginning SCN=9900 of database transaction 1005.

Database data blocks 520 include data blocks that store rows for table EMPLOYEE and change tracking table EMPLOG. For purposes of illustration, these data blocks are stored in a database buffer so that database transaction 1005 can make changes to these data blocks. The changes are not yet committed; accordingly, the transaction status for database transaction 1005 in TX STATUS is BEGUN. Similar to data blocks for database tables, entries for TX table 510 are also stored in data blocks, which may also be stored in an in-memory buffer.

Database transaction 1005 is changing data blocks 521 and 522, which store rows in EMPLOYEE changed by the database transaction 1005, and is changing data block 523, which stores the journal row in EMPLOG generated by the database transaction. The changes to these data blocks are recorded in redo records 531, 532, and 533 in redo buffer 515. In addition, the data blocks store transaction metadata, which includes an interested transaction list (ITL), which lists database transactions that are potentially modifying the data block. Each of data blocks 521, 522, and 523 includes database transaction ID 1005 in their respective ITLs.

Before database transaction 1005 is committed, the transaction status remains BEGUN. When another database transaction executes a query with a snapshot time of 9950, the database transaction reads, for example, data block 522. To determine whether the data block may be read for consistent read purposes, the database transaction examines the ITL of data block 522 to resolve any listed database transactions. The database transaction determines that the ITL includes transaction ID=1005. In response to this determination, the database transaction looks up the transaction status in TX table 510 and determines that the transaction status is BEGUN, meaning that database transaction 1005 is not committed and that data block 522 may reflect changes made by uncommitted database transaction 1005. In response to determining that the database transaction is not committed, the other database transaction performs consistent read operations, which may include creating a consistent read version of data block 522 by rolling back changes made by database transaction 1005.

As shown above, for a data block, an ITL entry's transaction ID serves as a reference to look up the status of a database transaction that may be changing the data block. Each data block being changed by a database transaction includes an entry in the ITL that refers to the status of the database transaction in this way.

To commit a database transaction, the TX STATUS in the entry for the database transaction in TX TABLE 510 is changed to COMMIT, and the TX SCN is set to the commit SCN of the database transaction. Only this entry needs to be changed in this way to record the fact that a database transaction is committed because a database transaction accessing a database block examines this entry. None of the data blocks changed by the database transaction need to be changed to reflect that the changes have been committed.

Before changing the entry in TX TABLE 510, redo records that are generated in the redo buffer by the database transaction must be persisted in the persistent redo log. Afterward, a “commit redo record” recording the change to the database transaction's entry in TX TABLE 510 is persisted in the redo log. Thus, all the redo records recording changes to data blocks made by a database transaction are persisted to the persistent redo log before the commit redo record is persisted.

In the current example, in the entry for database transaction 1005, TX STATUS is changed to COMMITTED, and TX SCN is changed to the commit SCN of 10000. The entry is stored in data block 524. The change to this data block is recorded in commit redo record 534 for database transaction 1005, similar to the way a redo record records a change to a data block for a database table.

A database transaction is not treated as committed before the commit record that records the change to the data block storing the transaction status in TX STATUS and commit SCN in TX SCN is persisted in the persistent redo log. In this way, a database transaction is atomically committed by persisting the commit redo record that records a change to a data block.

### Commit SCN Patching

To resolve any transaction inconsistency that arises by asynchronously updating a commit SCN column, a row is inserted into the commit SCN log separately at the very end of commit processing. The row includes the commit SCN of the database transaction. Specifically, the row is inserted along with TX TABLE at commit time after the commit SCN for a database transaction has been assigned. The commit redo record not only records the change to the TX table but also the insert of the row into the commit SCN log. Thus, the commit redo record stores changes to multiple data blocks. Recording a commit SCN column in this way is referred to as commit SCN patching.

If commit patching involves updating a commit SCN column in one or more change tracking tables to which a database transaction inserted journal rows, changes to multiple data blocks that store the journal rows might need to be recorded in a commit redo record. This creates additional overhead when performing commit patching. In fact, it may not be possible to record changes to all the data blocks in a commit redo record. For this reason, in an embodiment, the commit SCN, in effect, is normalized across change tracking tables by storing a database transaction's commit SCN in a commit SCN column of a single row of the commit SCN log.

FIG. 5B depicts commit patching to atomically commit database transaction 1005. A single commit redo record, which is persisted to the database transaction 1005, records not only the change to TX TABLE 510, but also a change to the commit SCN log to record the insert of the row having the commit SCN and database transaction ID of database transaction 1005.

Querying a change tracking table that filters rows based on commit SCNs involves joining a change tracking table with a commit SCN log. Finally, there may be embodiments that modify more than one commit SCN log. For example, there may be a commit SCN log for each set of multiple sets of change tracking tables. Commit patching may involve recording changes to multiple data blocks of respective commit SCN logs. While this may entail more overhead than needing to only modify one data block of one commit SCN log during commit patching, such overhead may be far less than having to record changes to multiple rows of one or more change tracking tables.

### Active Partition Succession

The operation of replacing an active partitioned table subfamily with a new active partitioned table subfamily is referred to herein as active partition succession. Once replaced, the former active partition of the commit SCN log is indexed. A procedure for active-partition succession shall be described later.

There are various factors pertinent to scheduling active-partition succession. One factor is the targeted degree of indexing. The shorter the interval between active-partition succession, the greater the proportion of the commit SCN log that is indexed and that may be accessed more efficiently. Another factor is storage space. Partitioned table subfamilies or a parent partition of the commit SCN log are assigned a threshold amount of storage to facilitate, for example, archiving or retention. Smaller thresholds allow archiving and retention to be performed with a finer degree of granularity.

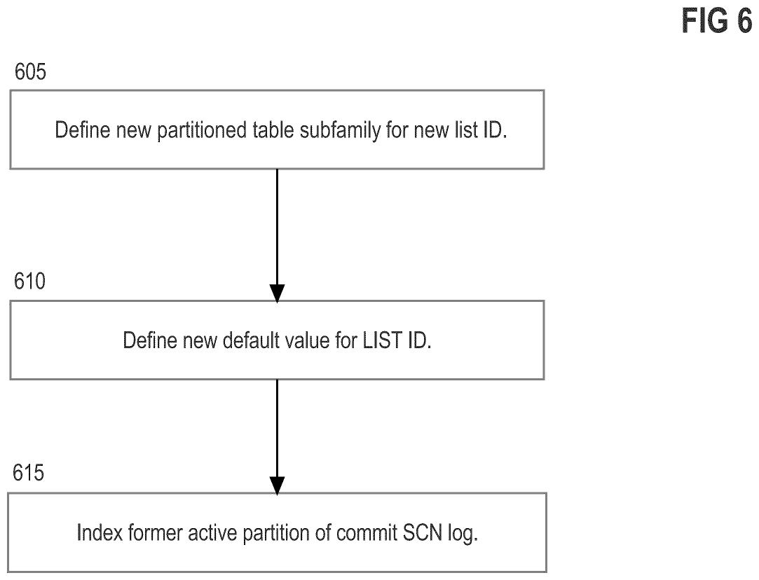

FIG. 6 depicts a procedure for active-partition succession. The procedure may be scheduled based on the factors discussed above. For example, the procedure may be performed in response to detecting that the active partitioned table family is about to fill the storage space allotted to the partitioned table family.

Referring to FIG. 6, a new partitioned-table subfamily is defined using list partitioning. (605) A new partition key value for the LIST ID column is assigned to the parent partition of the new partitioned table family. A partitioned table subfamily is defined by issuing DDL commands to the DBMS. The DDL command may specify tablespaces and/or storage segments to use to store database table data for the partitioned table family.

Next, the default value for column LIST ID of commit SCN log 230 is set to the new partition key value (610). Setting this default value deactivates the current active partitioned table subfamily and activates the new partitioned table subfamily as the active partitioned table subfamily. In this way, inserts to commit SCN log 230 are directed into the new active partitioned table subfamily. Thus, henceforth, rows inserted into change tracking tables 210 and 212 and commit SCN log 230 are inserted into the new active partitioned table subfamily.

If system partitioning is used, insert operations to a change tracking table and commit SCN log specify the respective partitions of the new partition table subfamily.

Finally, the deactivated partition of commit SCN log 230 is indexed by COMMIT_SCN. (2315)

Because the active partitioned table family is not indexed, queries that filter based on COMMIT_SCN may scan the entirety of the active partition of the commit SCN log 230 when none of the rows therein satisfy the filter predicate. A measure to ameliorate such scenarios is zone maps. Zone maps store information about the minimum and maximum values of a column stored in a set of data blocks. The set of data blocks may be an extent, which is a set of data blocks stored contiguously within an address space. The set of data blocks may be a partition and/or segment, which comprises one or more extents. The minimum and maximum values may be used to exclude (prune) a set of data blocks from scanning based on the minimum and maximum values. If no value between the minimum and maximum value inclusively can satisfy the filter predicate, then the set of data blocks may be excluded from table scanning because no row therein could satisfy the predicate value. Zone maps may be based on minimum and maximum commit SCNs stored in column COMMIT_SCN. Such zone maps would enable pruning for scans of the active partition that filter on COMMIT_SCN.

### SYS_CONTEXT

As mentioned previously, database session information may be journaled to a journal column. In an embodiment, the name of the journal column is SYS_CONTEXT.

In an embodiment, the database session information is stored as parameter values that may be associated with one or more namespaces. A DBMS may provide a default namespace with a default set of parameters. An example of such a namespace is USERENV, and parameters under this namespace include, for example, SESSIONID (database session of database transaction) and LANG (language used by a database session).

The following example DDL clauses illustrate how to specify to store a namespace parameter values in SYSCONTEXT or to specify particular parameter values, respectively.
CONTEXT NAMESPACE USERENV
CONTEXT NAMESPACE USERENV ATTRIBUTES SESSIONID, LANG

A DBMS may support user-defined namespaces and parameters. These may be specified in CONTEXT NAMESPACE clause.

### Handling User DDL Changes

Changes to the definition of a database object, such as a journaled table, are referred to herein as DDL changes. In general, a user may modify the definition of a database object by issuing an ALTER, RENAME, or DROP DDL statement.

A journal column has the same name and data type as the respective logged column. A DBMS automatically changes a journal column in the same way when the definition of the respective logged column is changed. For example, if the name or data type of a logged column is changed, the name or data type of the respective journal column is changed.

Making a DDL change to a journal column and/or change tracking table to mirror a DDL change made to the respective logged column and/or journaled table is referred to as a cascading DDL change or simply DDL cascading.

A table notification directive may dictate that all columns of a journaled table be journaled as logged columns. In response to a table notification directive dictating journaling all columns as logged columns in this way, a journal column is added to the change tracking table whenever a respective column is added to the journaled table.

DDL synchronization refers to preventing “conflicting” DDL changes to a database object from interfering with database transactions executing DML operations against the database object. To effect DDL synchronization, a database transaction issues DML locks against database objects accessed by DML operations. The DML locks are issued when compiling database commands and released when the database transaction terminates.

A database transaction making a DDL change to a database object requests a DDL lock on the database object. The DDL lock is not granted while the database object is locked by a DML lock. The request for DDL lock prevents granting subsequent DML locks requests made by other database transactions. Once a DDL lock is granted, the database transaction may make the DDL changes for which DDL lock was requested.

A DDL change to a journaled table may be cascaded to the respective change tracking table. For purposes of DDL synchronization, a database transaction making a DDL change to a journaled table requests a DDL lock on both the journaled table and the respective change tracking table. A database transaction that is performing a DML operation against a journaled table requests a DML lock on both the journaled table and the respective change tracking table. A database transaction making a DDL change directed to a change tracking table requests a DDL lock on the change tracking table and the respective journaled table.

Some DDL changes to a journaled table may not require any DDL changes to the respective change tracking table.

To prevent impacting the efficacy of table notification and even to prevent malfunctions, a DBMS restricts the type of DML changes and DDL changes an end user may effect on tables used by table notification. For example, changing the partitioning scheme of commit SCN log could break table notifications. Deleting rows from the commit SCN log that are linked to journal rows by database transactions breaks the functionality of historical views.

Accordingly, end users may not issue DDL changes to add columns to a change tracking table or commit SCN log, or change partitioning and other structural changes. End users may add indexes to a change tracking table, which are updated by a database transaction inserting journal rows into the change tracking table. An index may not be added to the commit SCN log.

Users may not delete journals rows or rows in the commit SCN log by issuing DML commands directed to a change tracking table or the commit SCN log. As mentioned before, users may call utilities to purge rows from a change tracking table. The utility maintains the integrity between the commit SCN log and any change tracking table, ensuring that the row for a database transaction is retained in the commit SCN log when the respective database transaction ID is held in any row of a change tracking table.

### Importing and Exporting

A database table may be exported. In general, the exporting a database table includes exporting database metadata defining the database table. For a journaled table, the table notification directive metadata accompanies the export. For example, a database table may be exported by storing the rows in a file. The file would include the metadata. The metadata is used to perform DDL commands to create the journaled table and change tracking table at the destination DBMS to which the journaled table and change tracking table are being exported.

The change tracking table can be exported along with the database table. In addition, the corresponding rows in the commit SCN log may be exported, i.e., the rows with database transaction IDs matching those in the exported journal rows, are exported along with the change tracking table. However, commit SCNs will likely be consistent with the SCN space at the destination DBMS. For this reason, exporting journal rows is performed optionally, but is permitted with the caveat that the imported commit SCNs may be inconsistent if not meaningless at the destination DBMS.

Table data import utilities may be used to import relatively large quantities of rows into a database table. In general, batches of rows are inserted within a database transaction. If the database table is a journaled table, the procedures described above may be used to journal the imported rows to the change tracking table.

### DBMS Overview

A database management system (DBMS) manages a database. A DBMS may comprise one or more database servers. A database comprises database data and a database dictionary that is stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically-marked data objects; however, the hierarchically-marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

A database command may also be in the form of an API call. The call may include arguments that each specifies a respective parameter of the database command. The parameter may specify an operation, condition, and target that may be specified in a database statement. A parameter may specify, for example, a column, field, or attribute to project, group, aggregate, or define in a database object.

In a DOCS, a database command may be in the form of functions or object method calls that invoke CRUD (Create Read Update Delete) operations. Create, update, and delete operations are analogous to insert, update, and delete operations in DBMSs that support SQL. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

When operations are referred to herein as being performed at commit time or as being commit time operations, the operations are performed in response to a request to commit a database transaction. DML commands may be auto-committed, that is, are committed in a database session without receiving another command that explicitly requests to begin and/or commit a database transaction. For DML commands that are auto-committed, the request to execute the DML command is also a request to commit the changes made for the DML command.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes. Database processes run under the control of the database server (i.e. can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g. shared access to a set of disk drives and data blocks stored thereon. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains definition metadata that defines properties of the database object. For example, definition metadata in a database dictionary defining a database table may specify the attribute names and data types of the attributes, and one or more files or portions thereof that store data for the table. Definition metadata in the database dictionary defining a procedure may specify a name of the procedure, the procedure's arguments, and the return data type, and the data types of the arguments and may include source code and a compiled version thereof.

A database dictionary is referred to by a DBMS to determine how to execute database commands submitted to a DBMS. Database commands can access or execute the database objects that are defined by the dictionary. Such database objects may be referred to herein as first-class citizens of the database. A first-class citizen is associated with a database object name, which can be referenced in database commands to identify the first-class citizen to DBMS. The database object name is mapped or otherwise associated with the database object. The DBMS refers to the definition metadata of the first-class citizen to determine how to access or execute the first-class citizen.

A database object may be defined by the database dictionary, but the definition metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e. .java file) and the compiled version of the class (i.e. . class file).

Native data types are data types supported by a DBMS “out-of-the-box”. Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as a valid data types and to be processed by a DBMS in database statements. In general, database software of a DBMS is programmed to recognize and process native data types without configuring the DBMS to do so by, for example, defining a data type by issuing DDL statements to the DBMS.

### Query Optimization and Execution Plans

Query optimization generates one or more different candidate execution plans for a query, which are evaluated by a DBMS to determine which execution plan should be used to compute the query.

Execution plans may be represented by a graph of interlinked nodes, referred to herein as operators or row sources, that each corresponds to a step of an execution plan, referred to herein as an execution plan operation. The hierarchy of the graphs (i.e., directed tree) represents the order in which the execution plan operations are performed and how data flows between each of the execution plan operations. An execution plan operator generates a set of rows (which may be referred to as a table) as output. Execution of an execution plan operator by a DBMS performs operations such as a table scan and row filtering, an index scan, a sort-merge join, a nested-loop join, filtering, and a full outer join.

A query optimization may optimize a query by transforming the query. In general, transforming a query involves rewriting a query into another semantically equivalent query that should produce the same result and that can potentially be executed more efficiently, i.e., one for which a potentially more efficient and less costly execution plan can be generated. Examples of query transformation include view merging, subquery unnesting, predicate move-around and pushdown, common subexpression elimination, outer-to-inner join conversion, materialized view rewrite, and star transformation.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

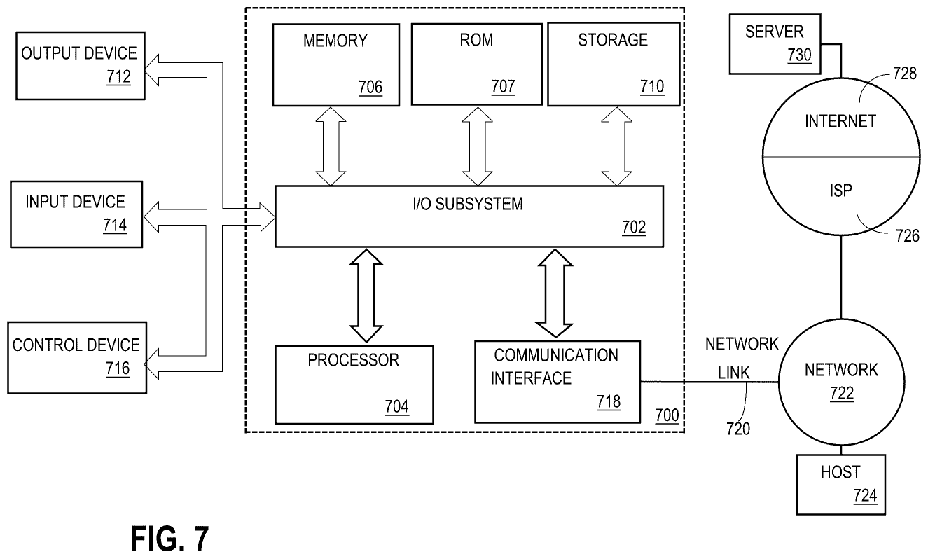

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### Software Overview

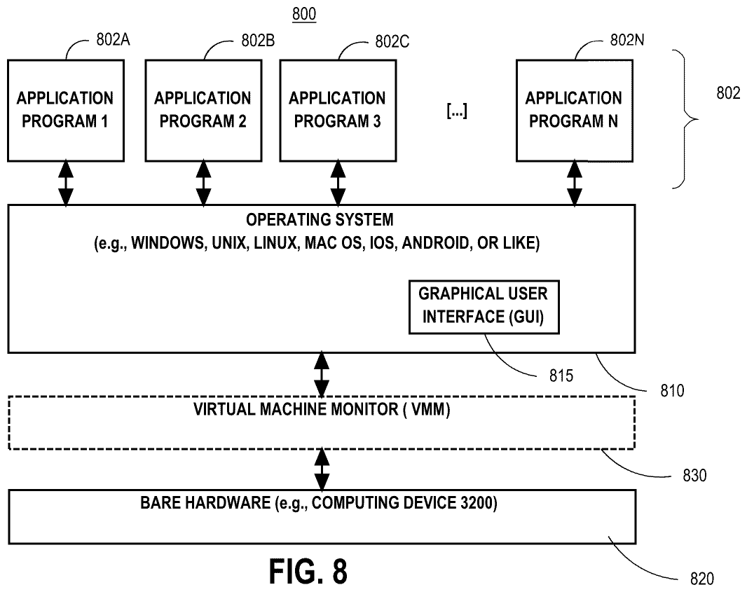

FIG. 8 is a block diagram of a basic software system 800 that may be employed for controlling the operation of computing system 800. Software system 800 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 800 is provided for directing the operation of computing system 700. Software system 800, which may be stored in system memory (RAM) 806 and on fixed storage (e.g., hard disk or flash memory) 810, includes a kernel or operating system (OS) 810.

The OS 810 manages low-level aspects of computer operation, including managing execution of processes, memory allocation, file input and output (I/O), and device I/O. One or more application programs, represented as 802A, 802B, 802C . . . 802N, may be “loaded” (e.g., transferred from fixed storage 810 into memory 806) for execution by the system 800. The applications or other software intended for use on computer system 700 may also be stored as a set of downloadable computer-executable instructions, for example, for downloading and installation from an Internet location (e.g., a Web server, an app store, or other online service).

Software system 800 includes a graphical user interface (GUI) 815, for receiving user commands and data in a graphical (e.g., “point-and-click” or “touch gesture”) fashion. These inputs, in turn, may be acted upon by the system 800 in accordance with instructions from operating system 810 and/or application(s) 802. The GUI 815 also serves to display the results of operation from the OS 810 and application(s) 802, whereupon the user may supply additional inputs or terminate the session (e.g., log off).

OS 810 can execute directly on the bare hardware 820 (e.g., processor(s) 804) of computer system 700. Alternatively, a hypervisor or virtual machine monitor (VMM) 830 may be interposed between the bare hardware 820 and the OS 810. In this configuration, VMM 830 acts as a software “cushion” or virtualization layer between the OS 810 and the bare hardware 820 of the computer system 700.

VMM 830 instantiates and runs one or more virtual machine instances (“guest machines”). Each guest machine comprises a “guest” operating system, such as OS 810, and one or more applications, such as application(s) 802, designed to execute on the guest operating system. The VMM 830 presents the guest operating systems with a virtual operating platform and manages the execution of the guest operating systems.

In some instances, the VMM 830 may allow a guest operating system to run as if it is running on the bare hardware 820 of computer system 800 directly. In these instances, the same version of the guest operating system configured to execute on the bare hardware 820 directly may also execute on VMM 830 without modification or reconfiguration. In other words, VMM 830 may provide full hardware and CPU virtualization to a guest operating system in some instances.

In other instances, a guest operating system may be specially designed or configured to execute on VMM 830 for efficiency. In these instances, the guest operating system is “aware” that it executes on a virtual machine monitor. In other words, VMM 830 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method executed on a database management system (“DBMS”) comprising:
a database transaction executing a DML command against a database table that changes one or more database table rows in said database table;
committing said database transaction, wherein committing said database transaction includes:
inserting one or more journal rows in a change tracking table, each journal row of said one or more journal rows storing a change made by said database transaction to a respective row of said one or more database table rows;
associating said database transaction with a commit SCN (system change number);
after said database transaction is committed, said changes to said one or more rows and said inserting one or more journal rows are visible at the commit SCN of said database transaction.

2. The method of claim 1, wherein said inserting is performed in response to a table notification directive specifying to journal changes to said change tracking table.

3. The method of claim 1,
wherein executing a DML command includes tracking changes to at least one logged column in said one or more database table rows in a row-change cache; and
wherein inserting one or more journal rows includes performing a batch insert of said one or more journal rows based change data in the row-change cache.

4. The method of claim 1, wherein a table notification directive defines a plurality of columns as logged columns having respective a journal column in said change tracking table that store respective column change values.

5. The method of claim 4, further including:
said DBMS receiving a request to change a definition of a particular logged column of said logged columns;
in response to said DBMS receiving a request to change said definition:
changing said definition of said particular logged column as specified by said request; and
changing a definition of the respective journal column in said change tracking table to mirror the definition of said particular logged column as changed for said request.

6. The method of claim 1, wherein committing said database transaction includes storing said commit SCN within a commit SCN column, wherein said commit SCN is visible within commit SCN column as of said commit SCN.

7. The method of claim 1, wherein committing said database transaction includes:
inserting a row into a commit SCN log that includes a commit SCN column for holding commit SCNs of committed database transactions;
wherein said commit SCN log includes a first key column that holds database transaction IDs including the database transaction ID of said database transaction; and
wherein said change tracking table includes a second key column that holds database transaction IDs, wherein said second key column of said one or more journal rows holds said database transaction ID of said database transaction.

8. The method of claim 7,
wherein said commit SCN log includes a particular plurality of partitions, said commit SCN log including a partitioning key; and
wherein said change tracking table includes a first plurality of partitions, wherein said change tracking table inherits the partitioning key of particular database table.

9. The method of claim 8, further including directing inserts of rows into said commit SCN log to a particular partition of said particular plurality of partitions as a current active partition of said particular plurality of partitions, wherein said commit SCN column of said particular partition is not indexed.

10. The method of claim 9, wherein the method further includes:
activating another partition of said commit SCN log as the current active partition; and
in response to activating another partition of said commit SCN log, indexing said commit SCN column of said particular partition.

11. The method of claim 7, further including:
persisting one or more redo records recording said changes to said one or more database table rows;
persisting a commit redo to commit said database transaction, said one or more redo records not including said commit redo record;
wherein said commit redo record records a change to a data block made to store said commit SCN in said row inserted into said commit SCN log; and
said commit redo record records a change to a data block of a transaction table that records the commit SCN of said database transaction.

12. The method of claim 2, wherein said table notification directive specifies to store particular database session information in a column of said change tracking table.

13. One or more non-transitory storage media storing one or more sequences of instructions which, when executed by one or more computing devices, cause:
a database transaction executing a DML command against a database table that changes one or more database table rows in said database table;
committing said database transaction, wherein committing said database transaction includes:
inserting one or more journal rows in a change tracking table, each journal row of said one or more journal rows storing a change made by said database transaction to a respective row of said one or more database table rows;
associating said database transaction with a commit SCN (system change number);
after said database transaction is committed, said changes to said one or more rows and said inserting one or more journal rows are visible at the commit SCN of said database transaction.

14. The one or more non-transitory storage media of claim 13, wherein said inserting is performed in response to a table notification directive specifying to journal changes to said change tracking table.

15. The one or more non-transitory storage media of claim 13,
wherein executing a DML command includes tracking changes to at least one logged column in said one or more database table rows in a row-change cache; and
wherein inserting one or more journal rows includes performing a batch insert of said one or more journal rows based change data in the row-change cache.

16. The one or more non-transitory storage media of claim 13, wherein a table notification directive defines a plurality of columns as logged columns having respective a journal column in said change tracking table that store respective column change values.

17. The one or more non-transitory storage media of claim 16, wherein the sequences of instructions include instructions that, when executed by one or more computing devices, cause:
said DBMS receiving a request to change a definition of a particular logged column of said logged columns;
in response to said DBMS receiving a request to change said definition:
changing said definition of said particular logged column as specified by said request; and
changing a definition of the respective journal column in said change tracking table to mirror the definition of said particular logged column as changed for said request.

18. The one or more non-transitory storage media of claim 13, wherein committing said database transaction includes storing said commit SCN within a commit SCN column, wherein said commit SCN is visible within commit SCN column as of said commit SCN.

19. The one or more non-transitory storage media of claim 13, wherein committing said database transaction includes:
inserting a row into a commit SCN log that includes a commit SCN column for holding commit SCNs of committed database transactions;
wherein said commit SCN log includes a first key column that holds database transaction IDs including the database transaction ID of said database transaction; and
wherein said change tracking table includes a second key column that holds database transaction IDs, wherein said second key column of said one or more journal rows holds said database transaction ID of said database transaction.

20. The one or more non-transitory storage media of claim 19,
wherein said commit SCN log includes a particular plurality of partitions, said commit SCN log including a partitioning key; and
wherein said change tracking table includes a first plurality of partitions, wherein said change tracking table inherits the partitioning key of particular database table.

21. The one or more non-transitory storage media of claim 20, wherein the sequences of instructions include instructions that, when executed by one or more computing devices, cause: directing inserts of rows into said commit SCN log to a particular partition of said particular plurality of partitions as a current active partition of said particular plurality of partitions, wherein said commit SCN column of said particular partition is not indexed.

22. The one or more non-transitory storage media of claim 21, wherein the sequences of instructions include instructions that, when executed by one or more computing devices, cause:
activating another partition of said commit SCN log as the current active partition; and
in response to activating another partition of said commit SCN log, indexing said commit SCN column of said particular partition.

23. The one or more non-transitory storage media of claim 19, wherein the sequences of instructions include instructions that, when executed by one or more computing devices, cause:
persisting one or more redo records recording said changes to said one or more database table rows;
persisting a commit redo to commit said database transaction, said one or more redo records not including said commit redo record;
wherein said commit redo record records a change to a data block made to store said commit SCN in said row inserted into said commit SCN log; and
said commit redo record records a change to a data block of a transaction table that records the commit SCN of said database transaction.

24. The one or more non-transitory storage media of claim 14, wherein said table notification directive specifies to store particular database session information in a column of said change tracking table.
